(19) United States
(12) Patent Application Publication
(10) Pub. No.: US 2023/0116295 A1
(43) Pub. Date: Apr. 13, 2023

(54) COOKING POT/PAN INCLUDING DISPOSABLE CONTAINER/LINER

(71) Applicant: Feindalt X Prinston, Montebello, NY (US)

(72) Inventor: Feindalt X Prinston, Montebello, NY (US)

(21) Appl. No.: 18/046,309

(22) Filed: Oct. 13, 2022

Related U.S. Application Data
(60) Provisional application No. 63/255,172, filed on Oct. 13, 2021.

(51) Int. Cl. A47J 36/02; A47J 36/16; A47J 36/06

(52) U.S. Cl. CPC A47J 36/022; A47J 36/06; A47J 36/16

(57) ABSTRACT

A cooking pot includes a cooking pot frame including a lip and a finger opening in the lip, a disposable container consisting of aluminum and a lip, and the disposable container slidably fits into the cooking pot frame. The cooking pot frame may include copper. The cooking pot frame lip may include finger openings. The cooking pot frame may include a lid and a handle. The disposable container may consist of aluminum foil or layers of aluminum foil.

### CROSS-REFERENCE TO RELATED APPLICATIONS

This application claims priority to US 63/255,172 filed on Oct. 13, 2021, herein incorporated by reference in its entirety.

### BACKGROUND OF THE INVENTION

The washing of dishes is disdained by many cooks. What is needed is a cooking pot with a cooking pan or liner that can be disposed of and/or recycled. This would also save energy and water use for the washing of pots and pans. It would also no longer be necessary to soak a pot and then wash it after use. A disposable cooking pot would allow one to simply drop a used pot into a recycling bin with no further cleanup.

### SUMMARY OF THE INVENTION

A cooking pot/pan includes a cooking pot/pan frame including a lip and a finger opening in the lip, a disposable pan/container/liner may consisting of aluminum and include a lip, and the disposable pan/container/liner slidably fits into the cooking pot frame. The cooking pot/pan frame may include copper. The cooking pot/pan frame lip may include finger openings. The cooking pot/pan frame may include a lid and a handle. The disposable pan/container/liner may consist of aluminum foil or layers of aluminum foil.

### BRIEF DESCRIPTION OF DRAWINGS

FIG. 1 shows an embodiment of a cooking pot of the disclosure.

FIG. 2 also shows an embodiment of a cooking pot of the disclosure.

FIG. 3 shows a blowup region of cooking pot frame of the disclosure.

FIG. 4 also shows an embodiment of a cooking pot of the disclosure.

FIG. 5 also shows an embodiment of a cooking pot of the disclosure.

FIG. 6 also shows an embodiment of a cooking pot of the disclosure.

FIG. 7 also shows an embodiment of a cooking pot of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION OF THE INVENTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The cooking pot of the disclosure can be made out of aluminum. It is a pot with a shape typical for cooking pots and includes an associated disposable container/liner and optionally a cover. The cooking pot frame may also have an attachable handle that allows a user to hold and maneuver it. Cooking can be done in the disposable container, and then leftovers can be stored in it if necessary, and it may be disposed or recycled once it has been used.

Accordingly, in embodiments the invention is directed to a cooking pot frame including an associated disposable container. The cooking pot frame may be made of any material generally used in the art for cooking pots, for example, copper, aluminum, stainless steel, iron including cast iron, ceramics, or composites, etc., and combinations thereof. Preferably, the cooking pot frame includes copper. Preferably, the cooking pot frame consists of copper.

The cooking pot frame and disposable container are of a shape used in the art for cooking pots. For example, spherical or cylindrical, although may be of other geometrical shapes, for example, ovular (ovoid), rectangular (rectangular parallelepiped), square (cube), or any 3D geometrical shape used in the art of cooking pots/pans. Cylindrical is preferred. A cooking pot frame and an associated disposable container generally have a geometry that is the same, i.e., are geometrically matched. For example, a cooking pot frame and an associated disposable container may be generally cylindrical in shape.

The thickness of the cooking pot frame may range from about 0.25 mm to about 10 mm thick. A range of about 1 mm to about 8 mm is preferred or about 2 mm to about 4 mm. The thickness may generally be uniform over the frame. In embodiments, a cooking pot frame may be of a multi-clad construction. A multi-clad construction may include one or more layers of the same or different materials. For example, there may be layers of copper, aluminum, iron, ceramic, or stainless steel.

The size of the cooking pot frame and the disposable container/liner can range according to the general sizes of cooking pots used in the art. For example, the cooking pot frame and disposable container may be generally cylindrical in shape and range from about 1 quart to about 12 quarts or more specifically including 1, 2, 3, 4, 5, 6, 7, 8, 9, 10, 11, and 12 quart sizes and including half quart sizes, e.g., 1.5 qt, 2.5 qt, etc., up to 12 qts. A generally cylindrical frame or disposable container may have a diameter ranging from about 3 inches to about 20 inches or about 6 inches to about 15 inches or about 8 inches to about 12 inches. The height of the cooking pot frame and disposable container may range from about 2 inches to about 16 inches or about 3 inches to about 12 inches or about 4 inches to about 6 inches (not including lid).

The cooking pot frame may optionally include a lip ranging from about ¼ inch to about 6 inches. Preferably, the lip may range from about 1 inch to about 4 inches, or about 2 inches to about 3 inches. In embodiments, the lip may completely encircle the frame at its top edge. In embodiments, the lip may include several finger openings. The openings provide sufficient space for a user’s fingers to remove a disposable container that is inserted into the cooking pot frame. The openings may range from about 1 inch to about 8 inches or about 3 inches to about 5 inches. The cooking pot frame lip may be made from the same material as the body of the cooking pot frame or a different material. Preferably, the lip is made from the same material as the body of the cooking pot frame. Preferably, the lip is made from the same material as the body of the cooking pot frame and the lip and the body of the cooking pot frame are integrally formed.

The disposable containers may include aluminum. Preferably, the disposable containers consist essentially of, or consist of, aluminum. The thickness of the disposable container may range from about 0.01 mm to about 0.4 mm thick. Preferably, the thickness range may be from about 0.05 to about 0.30 mm or about 0.1 mm to about 0.2 mm thick. The disposable container may consist of one or more layers of aluminum foil ranging from about 0.01 mm to about 0.05 mm thick each. There may be between 1 and 5 layers preferably between 2 and 4 layers. A layered construction may include formed ridges for added strength. The thickness may generally be uniform over the disposable container.

The disposable containers slidably fit into the cooking pot frame. A cylindrical disposable container sized for a cooking pot frame will have a diameter only slightly smaller than the cooking pot frame. The disposable container may accordingly be about the same diameter as the cooking pot frame diameter or slightly less, for example, about 0.001 mm to about 1.0 mm or about 0.001 to about 0.01 mm less than the diameter of the cooking pot frame. A disposable container that slidably fits into the cooking pot frame touches all sides of the frame but the fit is loose enough to be able to manually slide the disposable container out of the cooking pot frame.

The disposable containers may include a lip that surrounds a disposable container at its top edge. The lip may completely surround the disposable container. The container lip width may range from about ¼ inch to about 6 inches. Preferably, the container lip may range from about 1 inch to about 4 inches, or about 2 inches to about 3 inches. In preferred embodiments, the lip of the disposable container is approximately the same width as the cooking pot frame lip width. The lip may be made from the same material as the disposable container body or of a different material. Preferably, the lip is made from the same material as the disposable container party and the disposable container body and lip are integrally formed.

An attachable handle may also be included which attaches to the cooking pot frame. The cooking pot frame may also include a lid that fits onto the cooking pot frame and covers the frame. The handle may include a silicone coating. The lid may be made of the same material as cooking pot frame were of a different material. Preferably, the lid is made of the same material as the cooking pot frame.

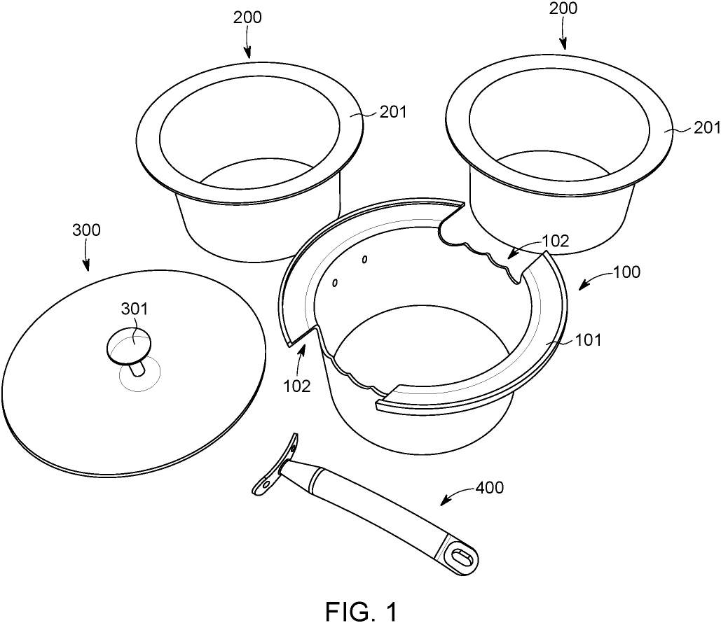

FIG. 1 shows an embodiment of a cooking pot of the disclosure. FIG. 1 shows cooking pot frame 100, with lip 101, and finger openings 102; disposable containers 200 including lip 201; lid 300 with knob 301; and handle 400 (not attached).

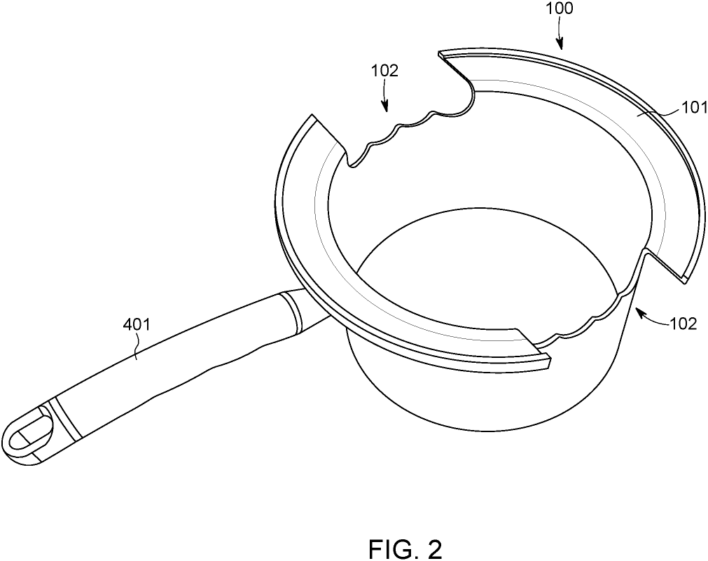

FIG. 2 also shows an embodiment of a cooking pot of the disclosure. FIG. 2 shows cooking pot frame 100 with finger openings 102 and attached handle 401.

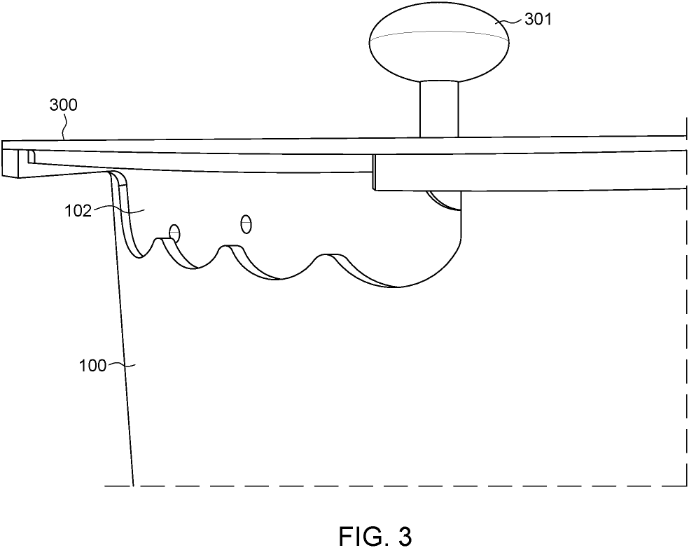

FIG. 3 shows a blowup region of cooking pot frame 100 showing finger opening 102. FIG. 3 further shows lid 300 with knob 301.

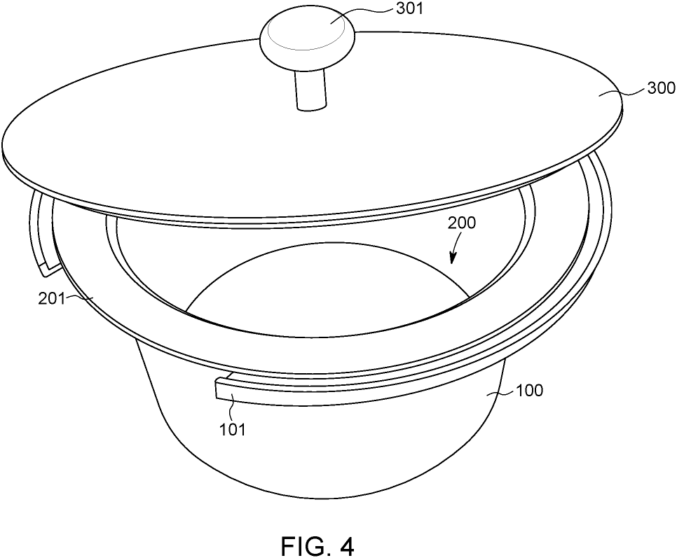

FIG. 4 also shows an embodiment of a cooking pot of the disclosure. FIG. 4 shows cooking pot frame 100 with lip 101; disposable container 200 with lip 201; and lid 300 (partially opened) with knob 301.

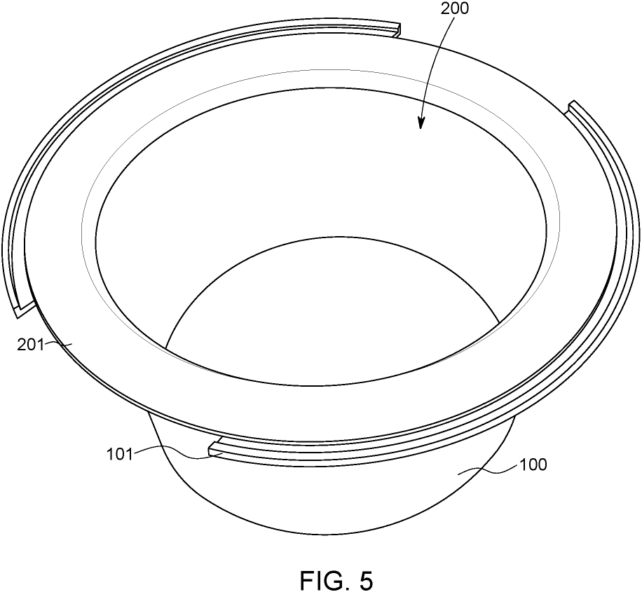

FIG. 5 also shows an embodiment of a cooking pot of the disclosure. FIG. 5 shows cooking pot frame 100 with lip 101; and disposable container 200 with lip 201.

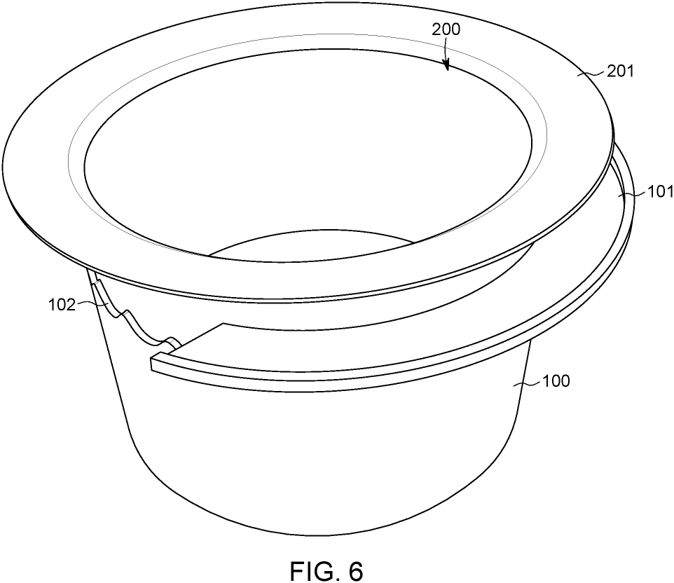

FIG. 6 also shows an embodiment of a cooking pot of the disclosure. FIG. 6 shows cooking pot frame 100 with lip 101 and finger opening 102; and disposable container 200 (partially inserted into the cooking pot frame 100) with lip 201.

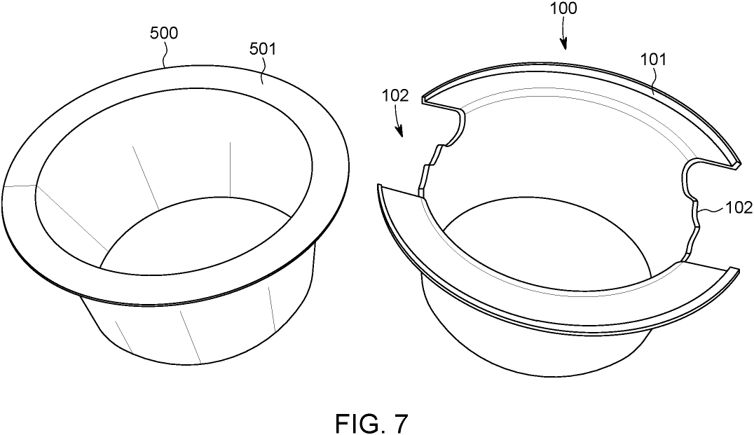

FIG. 7 also shows an embodiment of a cooking pot of the disclosure. FIG. 7 shows cooking pot frame 100 with lip 101 and finger openings 102; and disposable aluminum foil container 500 with lip 501.

While this disclosure includes specific examples, it will be apparent after an understanding of the disclosure of this application has been attained that various changes in form and details may be made in these examples without departing from the spirit and scope of the claims and their equivalents.

1-15. (canceled)

16. A cooking pot comprising:
a cooking pot frame ranging from about 1 quart to about 12 quarts in volume comprising copper, aluminum, stainless steel, or ceramic, ranging in thickness from about 1 mm to about 8 mm thick;
an associated disposable container ranging from about 1 quart to about 12 quarts comprising aluminum ranging from about 0.01 mm to about 0.1 mm thick and a lip ranging from about ¼ inch to about 6 inches wide;
wherein the cooking pot frame and the disposable container have about the same volume, are geometrically matched, and the disposable container slidably fits into the cooking pot frame.

17. The cooking pot of claim 16, wherein the cooking pot frame and disposable container have a cylindrical geometry.

18. The cooking pot of claim 16, wherein the disposable container consists of aluminum.

19. The cooking pot of claim 16, wherein the cooking pot frame comprises copper.

20. The cooking pot of claim 16, wherein the cooking pot frame further comprises a lip ranging from about ¼ inch to about 6 inches wide, the lip comprising two finger openings ranging from about 1 inch to about 4 inches long.

21. The cooking pot of claim 20, wherein the cooking pot frame and cooking pot frame lip are integrally formed.

22. The cooking pot of claim 20, wherein the cooking pot frame lip ranges from about 3 inches to about 4 inches wide.

23. The cooking pot of claim 16, wherein the cooking pot frame further comprises a lid and a handle.

24. The cooking pot of claim 16, wherein the thickness of the cooking pot frame ranges from about 2 mm to about 4 mm thick.

25. The cooking pot of claim 16, wherein the disposable container thickness ranges from about 0.1 mm to about 0.2 mm thick.

26. The cooking pot of claim 16, wherein the disposable container comprises between 1 and 5 layers of aluminum foil, each layer ranging from about 0.01 mm to about 0.05 mm thick.

27. The cooking pot of claim 16, wherein the disposable container and disposable container lip are integrally formed.
